(19) United States
(12) Patent Application Publication
(10) Pub. No.: US 2018/0272220 A1
(43) Pub. Date: Sep. 27, 2018

(54) System and Method of Remotely Coaching a Student's Golf Swing

(71) Applicants: Robert Glorioso, Palm Harbor, FL (US); Daniel Thomas Maestre, Clearwater, FL (US)

(72) Inventors: Robert Glorioso, Palm Harbor, FL (US); Daniel Thomas Maestre, Clearwater, FL (US)

(21) Appl. No.: 15/936,203

(22) Filed: Mar. 26, 2018

Related U.S. Application Data
(60) Provisional application No. 62/476,170, filed on Mar. 24, 2017.

(51) Int. Cl. A63B 69/36; G09B 5/02

(52) U.S. Cl. CPC A63B 69/36; G09B 5/02

(57) ABSTRACT

A method of remotely coaching a student's golf swing requires at least one remote server, a student personal computing (PC) device, and a coach PC device. The method begins by retrieving a live video feed of golf swings with the student PC device. The live video feed of golf swings is relayed from the student PC device, through the remote server, and to the corresponding coach PC device of a desired coach account. The live video feed of golf swings is displayed with the corresponding coach PC device. The desired coach account is prompted to enter a set of instructional feedback through the corresponding coach PC device. The set of instructional feedback is relayed from the corresponding coach PC device of the desired coach account, through the remote server, to the student PC device. The set of instructional feedback is outputted through the student PC device.

The current application claims a priority to the U.S. Provisional Patent application Ser. No. 62/476,170 filed on Mar. 24, 2017. The current application is filed on Mar. 26, 2018 while Mar. 24, 2018 was on a weekend.

### FIELD OF THE INVENTION

The present invention generally relates to golf. More specifically, the present invention allows a student and a coach to remotely communicate with each other as the student practices his or her swing.

### BACKGROUND OF THE INVENTION

Executing the perfect golf swing is a skill that even professional athletes must develop. While there are many ways to improve a player's overall golf game, receiving individual coaching is often the most effective when trying to improve upon a specific skill. Individual coaching gives a player real-time instruction from a trained professional, which eliminates any guessing on behalf of the player on his or her own personal progress. A coach is able to see the player perform and give the player tips and advice that has a tangible effect on exactly how the player swings at the ball. Because price and availability, finding and requesting a personal golf coach is often difficult and limited for many casual golfers. As a result, various virtual golf swing analyzing systems have been developed. These systems record and analyze the swing of a player to give pointers on how the swing can be improved. While these systems are often quite helpful, they lack the personal real-time touch of a live coach.

It is therefore the objective of the present invention to combine the professionalism of a real-time coach with the convenience of a virtual swing analyzer. A player is able to search and filter through local coaches and set up an in-person training. The present invention allows the player to virtually connect with any available coach. The present invention enables a user to transmit videos taken in a first-person perspective to a desired coach while communicating with the coach simultaneously. This open flow of communication enables the coach to advise the user of how to line up a shot and improve both stance and grip. The present invention couples this real-time communication with a swing analyzer system that captures footage of the swing and transmits this analysis to the coach. With the real-time footage of the swing and the analysis provided by the present invention, the desired coach is able to provide a detailed analysis and response about the swing of the player. In addition to real-time training, the player is able to personally review past swings and recommendations. In this way, the present invention enables a player to receive the training required to improve the accuracy and distance of a golf swing.

### BRIEF DESCRIPTION OF THE DRAWINGS

FIG. 1 is a schematic view for a system of the present invention.

FIG. 2 is a schematic view of the wireless communication of the present invention.

FIG. 3 is a flowchart illustrating the overall process for the present invention.

FIG. 4 is a flowchart illustrating the process for capturing a first-person perspective for a live video feed of golf swings with the hat-mountable camera of the present invention.

FIG. 5 is a flowchart illustrating the process for capturing a third-person perspective for a live video feed of golf swings with the hat-mountable camera of the present invention.

FIG. 6 is a flowchart illustrating the process for audibly outputting a set of instructional feedback with the wireless headset of the present invention.

FIG. 7 is a flowchart illustrating the process for displaying a set of performance metrics and a set of potential golf-swing problems with the student PC device of the present invention.

FIG. 8 is a flowchart illustrating the process for displaying the live video feed of golf swings with the student PC device of the present invention.

FIG. 9 is a flowchart illustrating the process for designating at least one best-match account from the plurality of coach accounts with the remote server of the present invention.

FIG. 10 is a flowchart illustrating the process for prompting the student account to select the desired coach account from the plurality of best-match accounts with the student PC device of the present invention.

FIG. 11 is a flowchart illustrating the process for displaying the student profile with the corresponding coach PC device of the desired coach account of the present invention.

FIG. 12 is a flowchart illustrating the process for enabling the remote server to exchange at least one direct message between the student account and the desired coach account through the remote server.

### DETAIL DESCRIPTIONS OF THE INVENTION

All illustrations of the drawings are for the purpose of describing selected versions of the present invention and are not intended to limit the scope of the present invention.

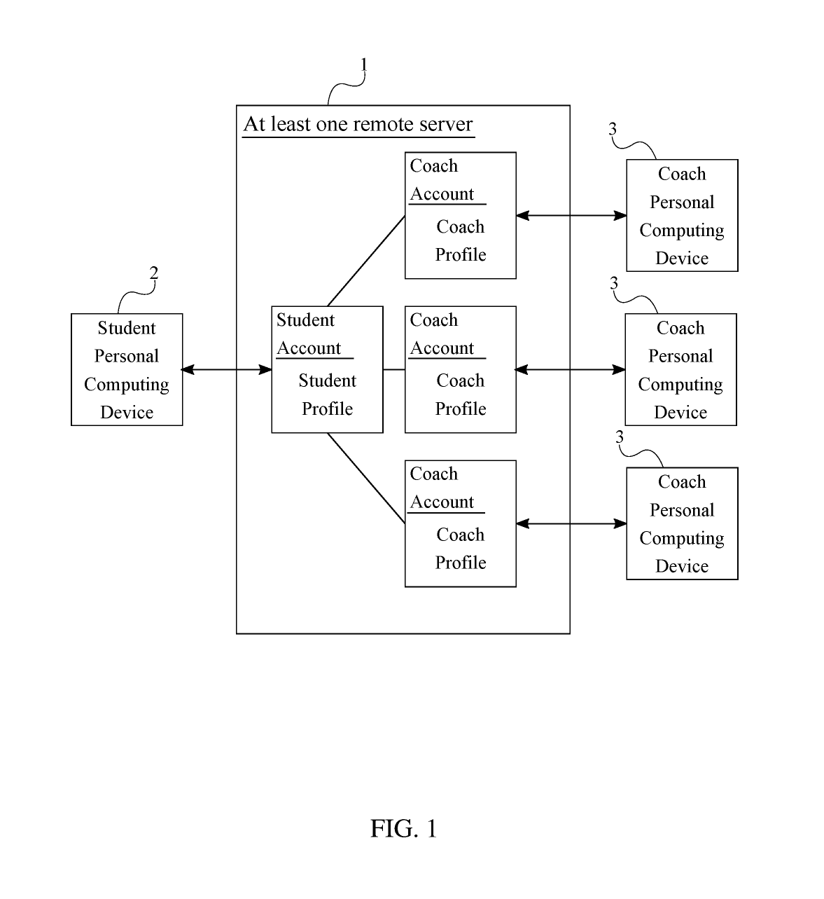

The present invention is a method of remotely coaching a student's golf swing. The present invention is used to connect a student with a coach that effectively guides the student based on the skill of the user and experience of the coach. The present invention allows the student to immediately locate and get in contact with a coach based on availability and location. Thus, the physical system used to implement the method of present invention includes at least one remote server 1, a student personal computing (PC) device 2, a corresponding coach PC device 3, as shown in FIG. 1. The at least one remote server 1 manages a student account and a plurality of coach accounts. The student account is associated to the student PC device 2 (Step A). Moreover, the student account allows a student to interface with the system of the present invention and allows the student to be uniquely identified by the system of the present invention. The student PC device 2 communicates with the plurality of coach accounts through the at least one remote server 1. Each coach account is associated to a corresponding coach PC device 3 (Step B). Similarly, the coach account allows a coach to interface with the system of the present invention and allows the coach to be uniquely identified in the system of the present invention in order for a student to select a specific coach. The student PC device 2 and the corresponding coach PC device 3 are preferably smart phones that utilizes the speaker, the microphone, the camera, the display screen, and the processing unit of the smart phone. In alternate embodiments of the present invention, the student PC device 2 and the corresponding coach PC device 3 may be a variety of other smart devices such as smart watches, tablets, and so on. The student PC device 2 and the corresponding coach PC device 3 are preferably portable. The student PC device 2 and the corresponding coach PC device 3 may each be a Wi-Fi hotspot as well.

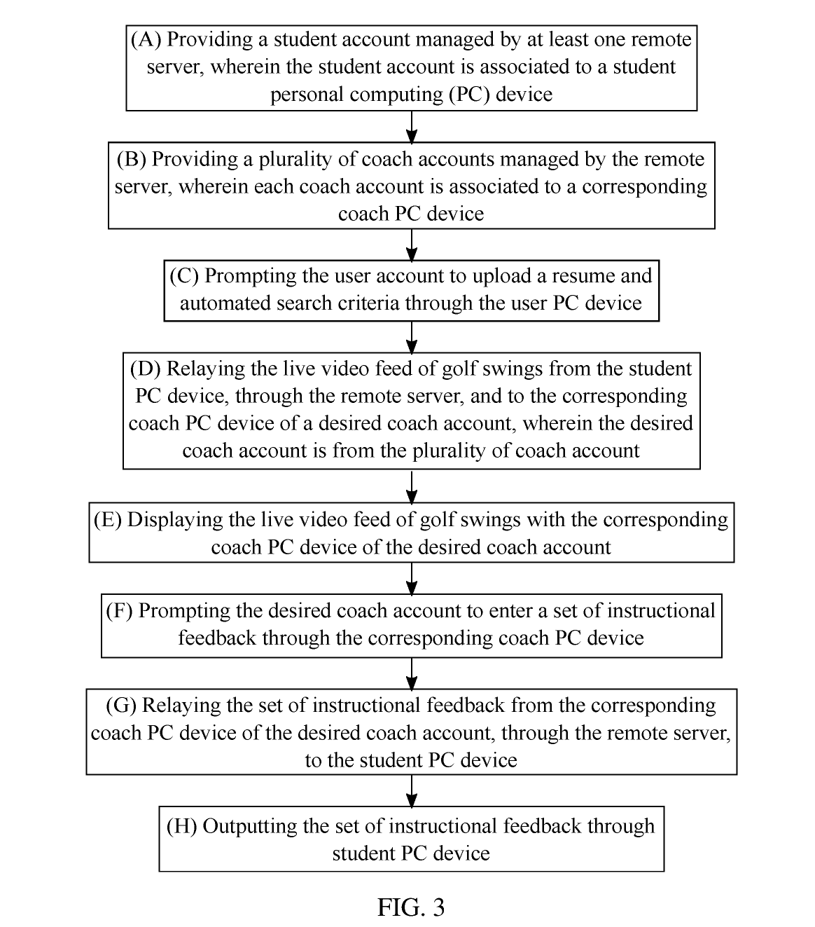

The overall process for the present invention includes the following steps that are implemented with the at least one remote server 1, the student PC device 2, and the coach PC device 3. As shown in FIG. 3, the overall process begins by retrieving a live video feed of golf swings with the student PC device 2 (Step C). The live video feed of golf swings is a recording of the golf swings of a student account that is analyzed by the at least one remote server 1 and a coach account. In order for the coach account to be able to view and analyze the live video feed of golf swings, the live video feed of golf swings is relayed from the student PC device 2, through the remote server 1, and to the corresponding coach PC device 3 of a desired coach account. The desired coach account is from the plurality of coach accounts (Step D) and has been purposefully selected by the student account based on availability, location, and merit. The desired coach account is able to provide feedback regarding the golf swings captured in the live video feed of golf swings as the live video feed of golf swings is displayed with the corresponding coach PC device 3 of the desired coach account (Step E). In order for the student account to receive the feedback from the desired coach account, the desired coach account is prompted to enter a set of instructional feedback through the corresponding coach PC device 3 (Step F), and the set of instructional feedback is then relayed from the corresponding coach PC device 3 of the desired coach account, through the remote server, to the student PC device 2 (Step G). The set of instructional feedback is outputted through the student PC device 2 (Step H) for the listening and/or viewing by the student account.

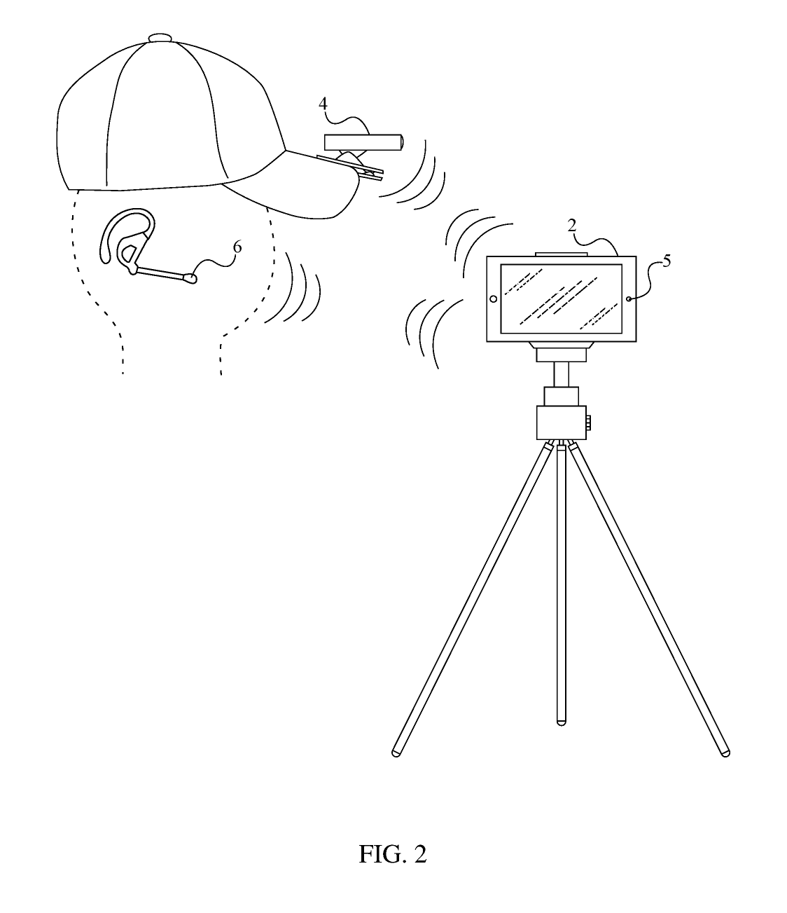

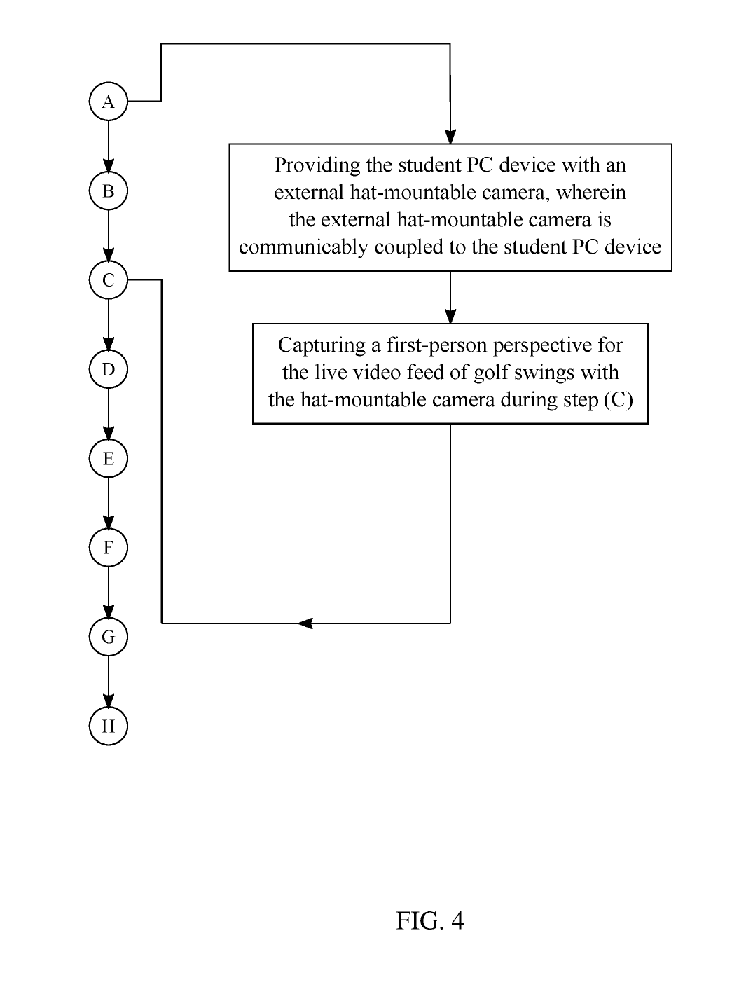

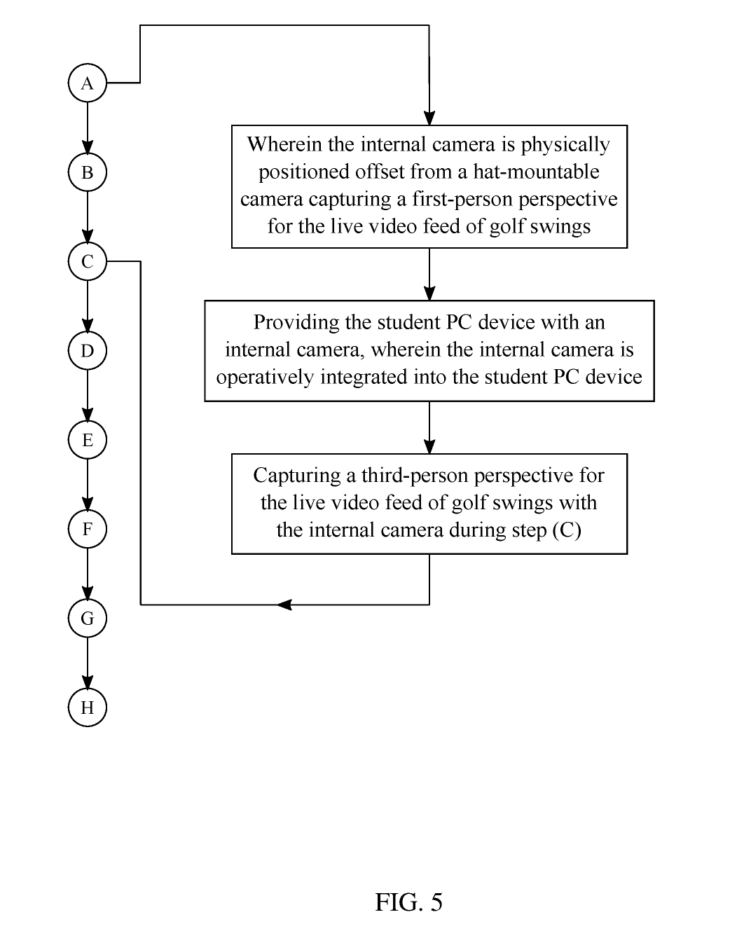

As shown in FIG. 2, the physical system used to capture the live video feed of golf swings in a first-person perspective includes the student PC device 2 with an external hat-mountable camera 4, wherein the external hat-mountable camera 4 is communicably coupled to the student PC device 2. The external hat-mountable camera 4 allows the desired coach account to be able to remotely view the golf swing with the corresponding coach PC device 3 as that of the student account. The external hat-mountable camera 4 preferably includes a clip, a hat, and camera that can be readily attached or separated from a hat. More specifically, the first-person perspective for the live video feed of golf swings is captured with the hat-mountable camera 4 during Step C, shown in FIG. 4. Also seen in FIG. 2, the physical system used to capture the live video feed of the golf swings further includes the student PC device 2 with an internal camera 5, wherein the internal camera 5 is operatively integrated into the student PC device 2. The live video feed of golf swings captured by the internal camera 5 captures the live video feed of golf swings in a third-person perspective which allows the desired coach account to view the entire form of the swing of the student account with the corresponding coach PC device 3. Similarly, the third-person perspective for the live video feed of golf swings is captured with the internal camera 5 during Step C. More specifically, the internal camera 5 is physically positioned offset from a hat-mountable camera capturing the first-person perspective for the live video feed of golf swings, as seen in FIG. 5. The student PC device 2 with the internal camera 5 is preferably stabilized with a mount or tripod.

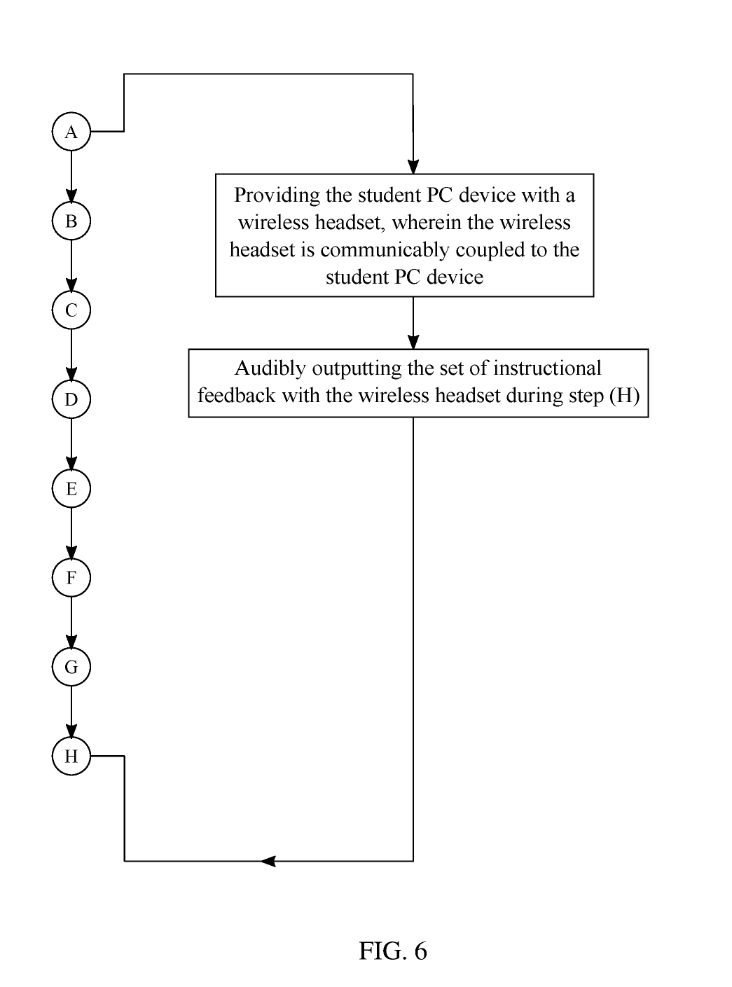

In order for the student account to be able to audibly communicate with the desired couch account through the student PC device 2 and the corresponding coach PC device 3 while swinging, the physical system used to capture live video feed of golf swings provides the student PC device 2 with a wireless headset 6, as seen in FIG. 2. The wireless headset 6 is communicably coupled to the student PC device 2 allowing golf swings to be made freely. More specifically, the set of instructional feedback is audibly outputted with the wireless headset 6 during Step H, as seen in FIG. 6. The desired coach account is able to audibly provide a set of instructional feedback as the live video feed of golf swings is being captured, and the student account is able to respond to the set of instructional feedback in real-time.

The student account is able to view and track the progress of golf swings at a later time as the live video feed of golf swings is stored on the remote server during Step D. Whenever the live video feed of golf swings, which have been stored on the remote server 1, is ready to be viewed, the student account is prompted to view the live video feed of golf swings with the student PC device 2 after Step H. The live video feed of golf swings is then relayed from the remote server 1 to the student PC device 2, if the student account confirms to view the live video feed of golf swings. The live video feed of golf swings is then displayed with the student PC device 2. The student PC device 2 is able to present to the student account with a specific live video feed of golf swings that has been previously captured by either the external hat-mountable camera 4 or the internal camera 5, or both the external hat-mountable camera 4 and the internal camera 5.

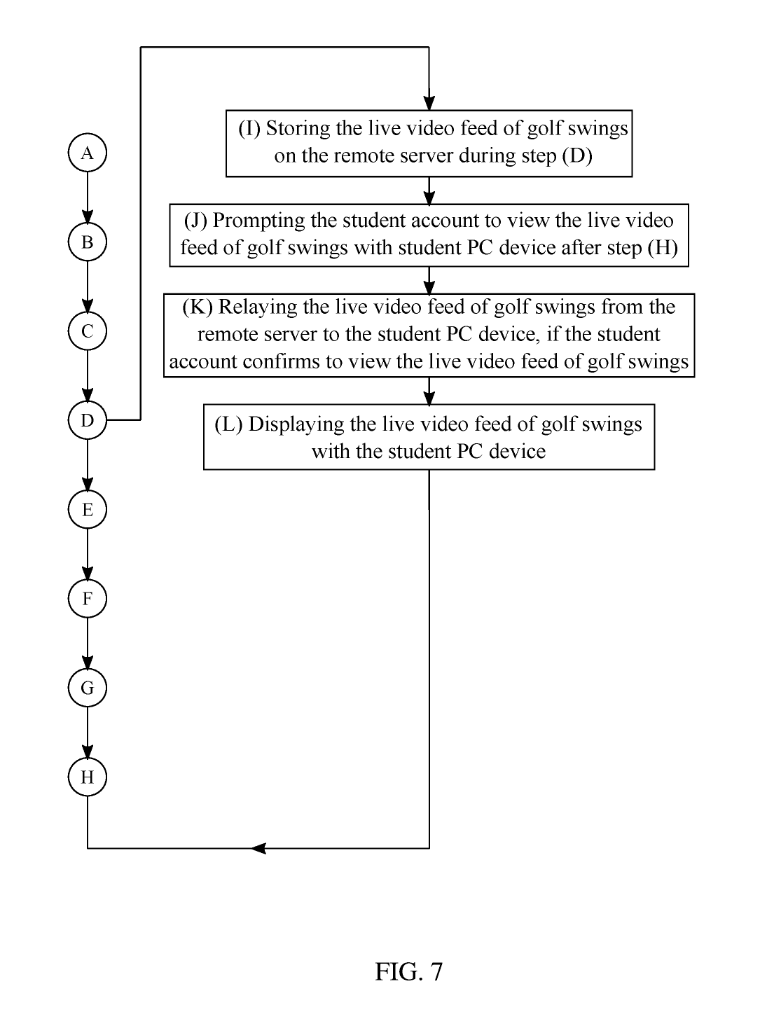

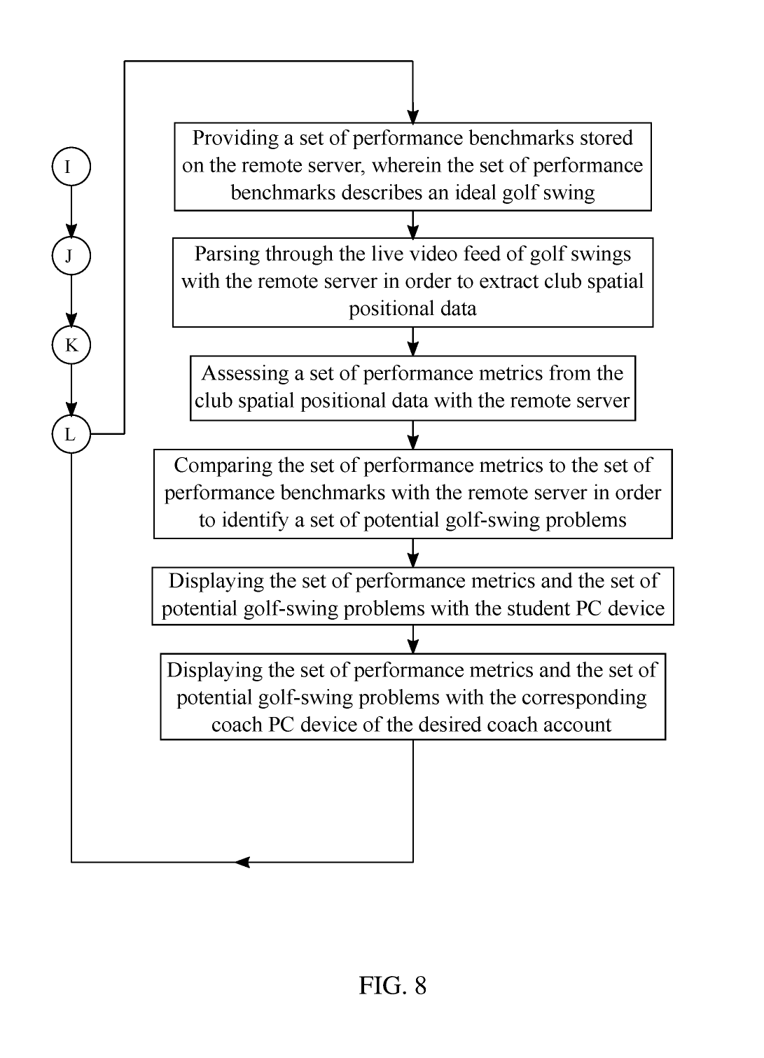

In order to measure the progress of the golf swings of the student account, a set of performance benchmarks stored on the remote server 1 is provided, wherein the set of performance benchmarks describes an ideal golf swing, as seen in FIG. 7. The live video feed of golf swings is parsed through with the remote server 1 in order to extract club spatial positional data. Club spatial positional data may include, but is not limited to, the angle of the head of the club, the angle of the handle of the club, the follow through distance of the club once the head of the club has hit the golf ball, and so on. A set of performance metrics from the club spatial positional data is assessed with the remote server 1 and is compared to the set of performance benchmarks with the remote server in order to identify a set of potential golf-swing problems. Such golf-swing problems include poor alignment, limited or no acceleration, wrong golf club selection, poor timing, and so on. The set of performance metrics and the set of potential golf-swing problems is displayed with the student PC device 2 and the corresponding coach PC device 3 of the desired coach account, seen in FIG. 8. Consequently, the student account is able to directly analyze the live video feed of golf swings, and the coach account is able to provide a more detailed and accurate set of instructional feedback.

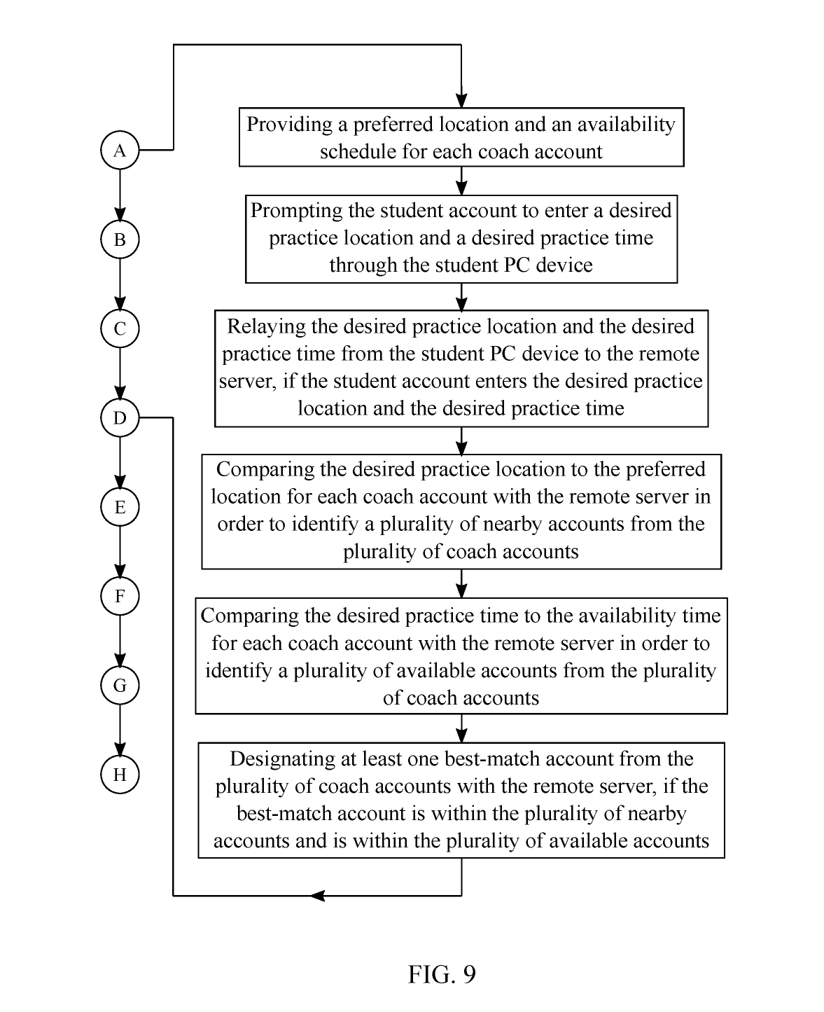

As seen in FIG. 9, the present invention further includes a preferred location and an availability schedule for each coach account in order for the student account to effectively select a desired coach account from the plurality of coach accounts. The preferred location may be a specific area or zip code; however, the preferred location is preferably identified as a specific golf course. The availability schedule for each coach account presents to the student account when the coach account is free for a coaching session and when the coach is already booked with another student account. In order for the student account to select the desired coach account from the plurality of coach accounts, the student account is prompted to enter a desired practice location and a desired practice time through the student PC device 2. The present invention filters through the plurality of coach accounts as the desired practice location and the desired practice time from the student PC device 2 is relayed from the student PC device 2 to the remote server 1, if the student account enters the desired practice location and the desired practice time. The desired practice location is compared to the preferred location for each coach account with the remote server 1 in order to identify a plurality of nearby accounts from the plurality of coach accounts. Similarly, the desired practice time is compared to the availability time for each coach account with the remote server 1 in order to identify a plurality of available accounts from the plurality of coach accounts. At least one best-match account from the plurality of coach accounts is then designated with the remote server 1, if the best-match account is within the plurality of nearby accounts and is within the plurality of available accounts. The best-match accounts are the coach accounts that are located closest to the student account and are available during the student account's training time

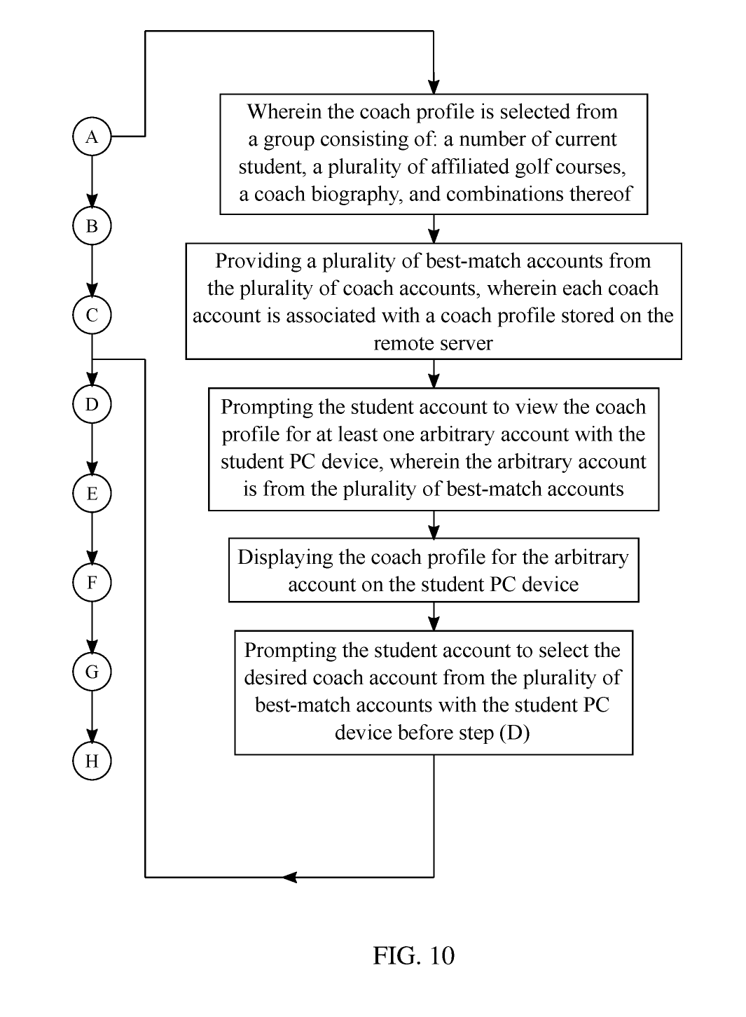

As seen in FIG. 10, a plurality of best-match accounts from the plurality of coach accounts is then provided, wherein each coach account is associated with a coach profile stored on the remote server 1. In order to select and communicate with a desired coach account through the corresponding coach PC device 3, the student account is prompted to view the coach profile for at least one arbitrary account with the student PC device 2, wherein the arbitrary account is from the plurality of best-match accounts. The coach profile for the arbitrary account is displayed on the student PC device 2, thereby facilitating the filtering through the plurality of best-match accounts by the student account. The coach profile includes, but is not limited to, a number of current students, a plurality of affiliated golf courses, and a coach biography. Upon the review of the coach profile for at least one arbitrary account, the student account is prompted to select the desired coach account from the plurality of best-match accounts with the student PC device 2 before Step D. The desired coach account then confirms or denies the selection of the student account which is presented to the desired coach account as a contact request. The confirmation of the contact request allows the student account and the coach account to directly communicate with the student PC device 2 and the corresponding coach PC device 3.

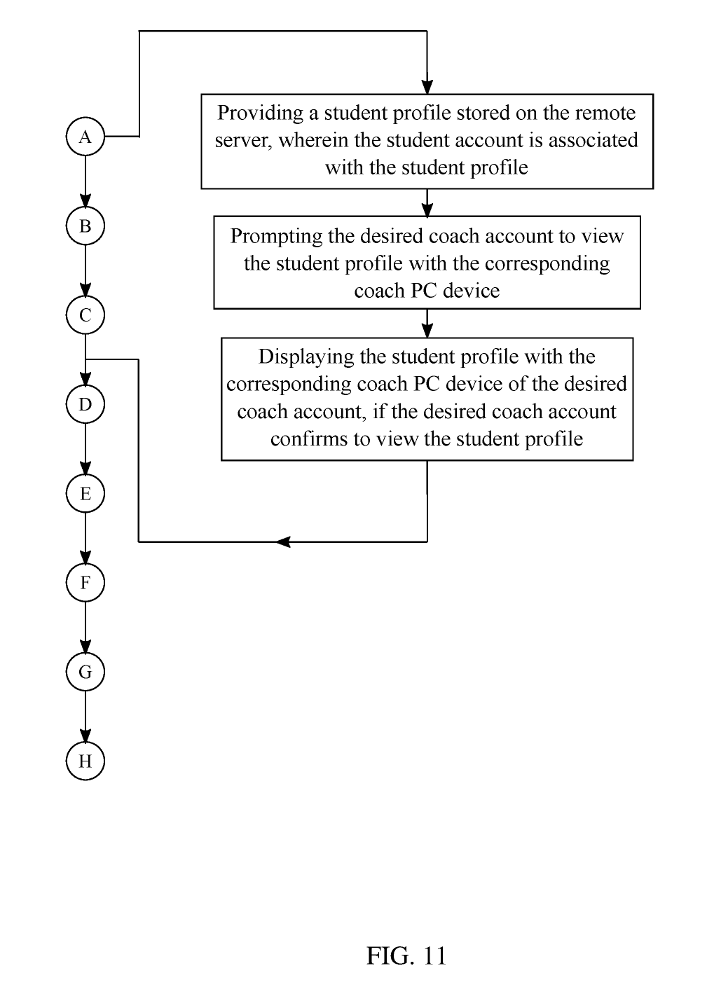

In order for the desired coach account to effectively coach the student account, the present invention further includes a student profile stored on the remote server 1, wherein the student account is associated with the student profile, as seen in FIG. 11. The student profile presents any and all live video feed of golf swings, the set of performance metrics and the set of potential golf-swing problems for each live video feed of golf swings, and any data regarding the golf swing skills corresponding to the student account. The desired coach account is prompted to view the student profile with the corresponding coach PC device 3, so that the desired coach account may view all the available information regarding the progress of the student account. The student profile is displayed with the corresponding coach PC device 3 of the desired coach account, if the desired coach account confirms to view the student profile, thereby allowing the desired coach account to provide an accurate set of instructional feedback.

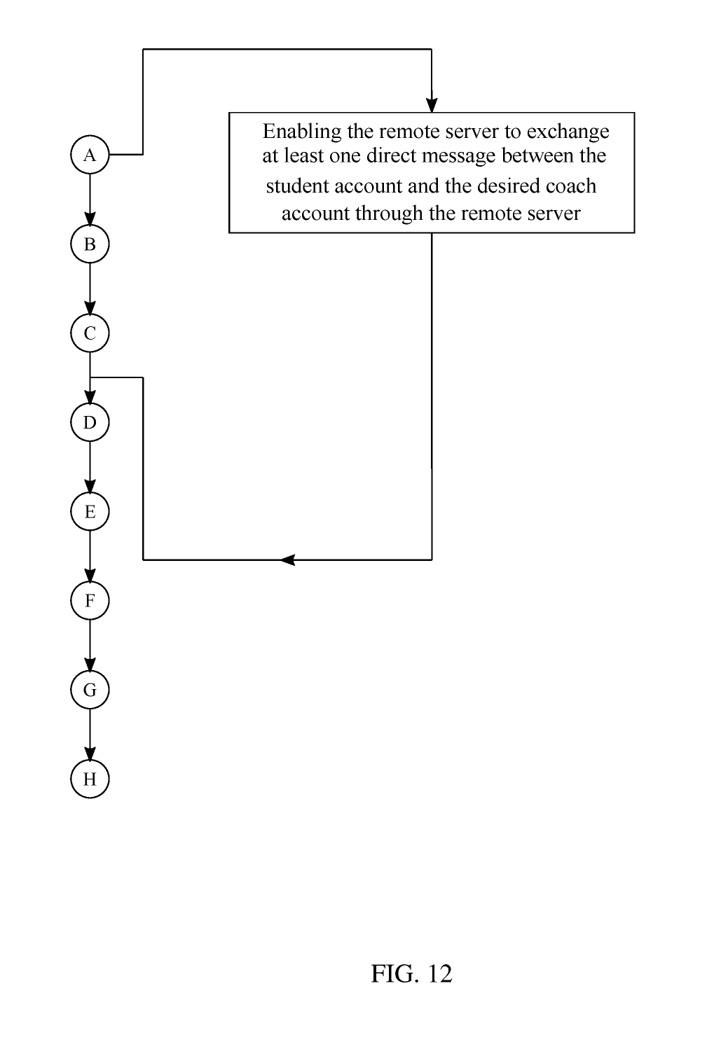

The student account and the desired coach account are able to directly communicate with each other with the present invention as the remote server 1 is enabled to exchange at least one direct message between the student accounts and the desired coach account through the remote server, as seen in FIG. 12. The at least one direct message may deliver a push notification to the student PC device 2 and the corresponding PC device 3, respectively. The at least one direct message preferably provides information regarding the time and location of a coaching session, the price of a coaching session, and preferably any golf-coaching related information.

Although the invention has been explained in relation to its preferred embodiment, it is to be understood that many other possible modifications and variations can be made without departing from the spirit and scope of the invention as hereinafter claimed.

What is claimed is:

1. A method of remotely coaching a student's golf swing, the method comprises the steps of:
(A) providing a student account managed by at least one remote server, wherein the student account is associated to a student personal computing (PC) device;
(B) providing a plurality of coach accounts managed by the remote server, wherein each coach account is associated to a corresponding coach PC device;
(C) retrieving a live video feed of golf swings with the student PC device;
(D) relaying the live video feed of golf swings from the student PC device, through the remote server, and to the corresponding coach PC device of a desired coach account, wherein the desired coach account is from the plurality of coach accounts;
(E) displaying the live video feed of golf swings with the corresponding coach PC device of the desired coach account;
(F) prompting the desired coach account to enter a set of instructional feedback through the corresponding coach PC device;
(G) relaying the set of instructional feedback from the corresponding coach PC device of the desired coach account, through the remote server, to the student PC device; and
(H) outputting the set of instructional feedback through student PC device.

2. The method of remotely coaching a student's golf swing, the method as claimed in claim 1 comprises the steps of:
providing the student PC device with an external hat-mountable camera, wherein the external hat-mountable camera is communicably coupled to the student PC device; and
capturing a first-person perspective for the live video feed of golf swings with the hat-mountable camera during step (C).

3. The method of remotely coaching a student's golf swing, the method as claimed in claim 1 comprises the steps of:
providing the student PC device with an internal camera, wherein the internal camera is operatively integrated into the student PC device; and
capturing a third-person perspective for the live video feed of golf swings with the internal camera during step (C).

4. The method of remotely coaching a student's golf swing, the method as claimed in claim 3, wherein the internal camera is physically positioned offset from a hat-mountable camera capturing a first-person perspective for the live video feed of golf swings.

5. The method of remotely coaching a student's golf swing, the method as claimed in claim 1 comprises the steps of:
providing the student PC device with a wireless headset, wherein the wireless headset is communicably coupled to the student PC device; and
audibly outputting the set of instructional feedback with the wireless headset during step (H).

6. The method of remotely coaching a student's golf swing, the method as claimed in claim 1 comprises the steps of:
storing the live video feed of golf swings on the remote server during step (D);
prompting the student account to view the live video feed of golf swings with student PC device after step (H);
relaying the live video feed of golf swings from the remote server to the student PC device, if the student account confirms to view the live video feed of golf swings; and
displaying the live video feed of golf swings with the student PC device.

7. The method of remotely coaching a student's golf swing, the method as claimed in claim 6 comprises the steps of:
providing a set of performance benchmarks stored on the remote server, wherein the set of performance benchmarks describes an ideal golf swing;
parsing through the live video feed of golf swings with the remote server in order to extract club spatial positional data;
assessing a set of performance metrics from the club spatial positional data with the remote server;
comparing the set of performance metrics to the set of performance benchmarks with the remote server in order to identify a set of potential golf-swing problems;
displaying the set of performance metrics and the set of potential golf-swing problems with the student PC device; and
displaying the set of performance metrics and the set of potential golf-swing problems with the corresponding coach PC device of the desired coach account.

8. The method of remotely coaching a student's golf swing, the method as claimed in claim 1 comprises the steps of:
providing a preferred location and an availability schedule for each coach account;
prompting the student account to enter a desired practice location and a desired practice time through the student PC device;
relaying the desired practice location and the desired practice time from the student PC device to the remote server, if the student account enters the desired practice location and the desired practice time;
comparing the desired practice location to the preferred location for each coach account with the remote server in order to identify a plurality of nearby accounts from the plurality of coach accounts;
comparing the desired practice time to the availability time for each coach account with the remote server in order to identify a plurality of available accounts from the plurality of coach accounts; and
designating at least one best-match account from the plurality of coach accounts with the remote server, if the best-match account is within the plurality of nearby accounts and is within the plurality of available accounts.

9. The method of remotely coaching a student's golf swing, the method as claimed in claim 1 comprises the steps of:
providing a plurality of best-match accounts from the plurality of coach accounts, wherein each coach account is associated with a coach profile stored on the remote server;
prompting the student account to view the coach profile for at least one arbitrary account with the student PC device, wherein the arbitrary account is from the plurality of best-match accounts;
displaying the coach profile for the arbitrary account on the student PC device; and
prompting the student account to select the desired coach account from the plurality of best-match accounts with the student PC device before step (D).

10. The method of remotely coaching a student's golf swing, the method as claimed in claim 9, wherein the coach profile is selected from a group consisting of: a number of current student, a plurality of affiliated golf courses, a coach biography, and combinations thereof.

11. The method of remotely coaching a student's golf swing, the method as claimed in claim 1 comprises the steps of:
providing a student profile stored on the remote server, wherein the student account is associated with the student profile;
prompting the desired coach account to view the student profile with the corresponding coach PC device; and
displaying the student profile with the corresponding coach PC device of the desired coach account, if the desired coach account confirms to view the student profile.

12. The method of remotely coaching a student's golf swing, the method as claimed in claim 1 comprises the step of:
enabling the remote server to exchange at least one direct message between the student account and the desired coach account through the remote server.
